(19) United States
(12) Patent Application Publication
(10) Pub. No.: US 2007/0049124 A1
(43) Pub. Date: Mar. 1, 2007

(54) Audio jack with inclined coupling end face

(75) Inventors: Min-Ling Chien, Taipei (TW); Kai-Ray Cheng, Taipei (TW); Jian Cheng, Taipei (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/411,791

(22) Filed: Apr. 27, 2006

(30) Foreign Application Priority Data
Aug. 26, 2005 (TW) 094214712

(51) Int. Cl. H01R 24/04

(52) U.S. Cl. 439/668

(57) ABSTRACT

An audio jack includes a parallelepiped insulative housing 10 including a tapered, inclined rear end 13 having four sides wherein two sides are longer, the other two sides are shorter, the longer sides are inclined, and the four sides are coupled together; first, second, third, and fourth conductors 21, 22, 23, and 24 each having an outer terminal 212, 222, 231, or 241 inclined and projected from the rear end 13; a plate 20 mounted inside the housing 10; and a metal shell 30 of rectangular section including a plurality of inclined legs 32 extended from sides of its rear end 31; The housing 10 further comprises a plurality of internal cavities 1311 for positioning the first, second, third, and fourth conductors 21, 22, 23, and 24. The invention can effectively utilize a limited space of an electronic device.

### BACKGROUND OF THE INVENTION

1. Field of Invention

The present invention relates to electrical connectors, and more particularly to an audio jack having an inclined coupling end face so as to effectively utilize a limited space of an electronic device.

2. Description of Related Art

Conventionally, an audio jack is responsible for providing an effective medium for signal transmission between two electronic communication devices. It is understood that an audio jack having an improved shape, a reduced space, or other advantageous benefits may contribute significantly to the advancement of the art.

### SUMMARY OF THE INVENTION

It is therefore an object of the present invention to provide an audio jack having an inclined end face to be couple with a PCB so as to effectively utilize a limited space of an electronic device.

It is another object of the present invention to provide an audio jack comprising a couple of conductors having its bent inner terminals positioned in internal cavities of the audio jack housing so as to provide an elastic buffering and fastening effect when a plug is inserted into the audio jack.

To achieve the above and other objects, the present invention provides an audio jack comprising a parallelepiped insulative housing including a tapered, inclined rear end having four sides wherein two sides are longer, the other two sides are shorter, the longer sides are inclined, and the four sides are coupled together; first, second, third, and fourth conductors each having an outer terminal inclined and projected from the rear end; a plate mounted inside the housing; and a metal shell of rectangular section including a plurality of inclined legs extended from sides of its rear end; wherein the housing further comprises a plurality of internal cavities for positioning the first, second, third, and fourth conductors.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of audio jack according to the invention to be assembled with its metal shell;

FIG. 2 is an exploded view of the audio jack without the shell from an opposite angle;

FIG. 3 is a side elevation view of the assembled audio jack and the shell;

FIG. 4 is a sectional view of FIG. 3 but viewed oppositely;

FIG. 5 is a perspective view of FIG. 3 mounted with a PCB; and

FIG. 6 is a perspective view of a second preferred embodiment of audio jack according to the invention to be assembled with a PCB.

### DETAILED DESCRIPTION OF THE INVENTION

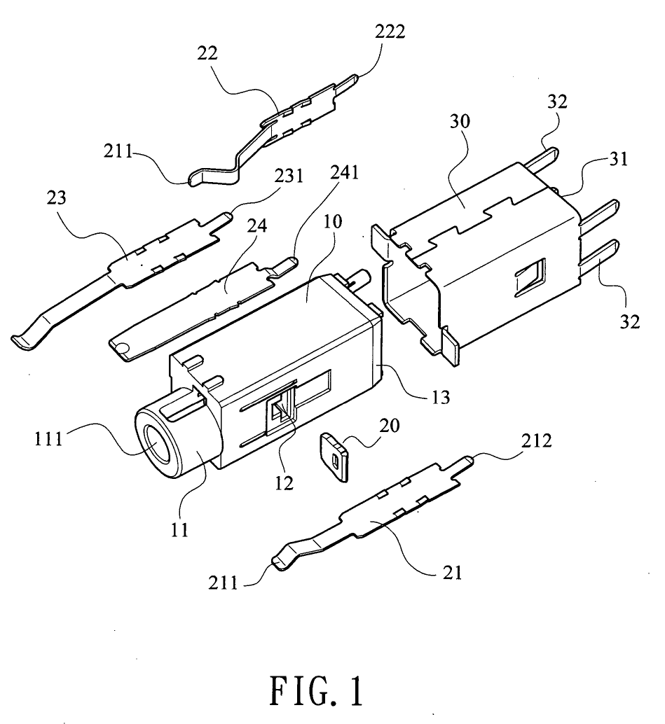

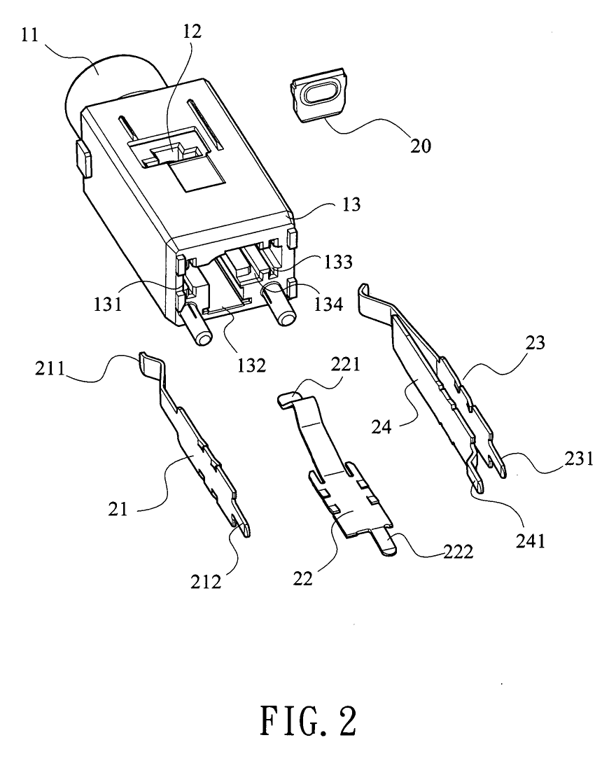

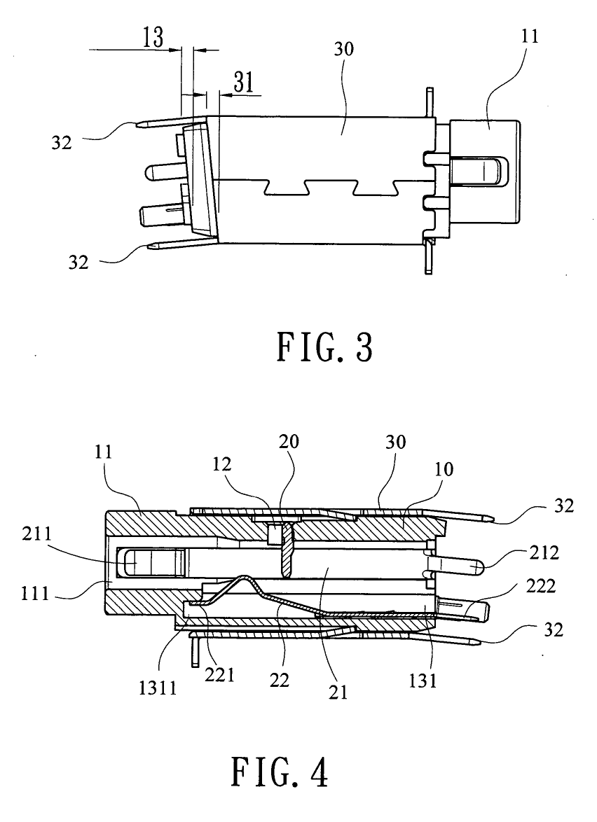

Referring to FIGS. 1 to 6, an audio jack in accordance with the invention comprises an elongated parallelepiped insulative housing 10 including a front projected cylinder 11 having an axial channel 111 in communication with an internal space of the housing 10, first, second, third, and fourth grooves 131, 132, 133, and 134 in the housing 10, and a lateral slot 12 which has its both ends terminated at an outer surface of the housing 10 and the internal space thereof. A plate 20 is adapted to mount inside the slot 12. The housing 10 has a short tapered, inclined rear end 13. Within the rear end 13, the first, second, third, and fourth grooves 131, 132, 133, and 134 are formed. A cavity 1311 is formed at a closed end of each of the first and second grooves 131 and 132. The short tapered, inclined rear end 13 is constructed as one has four sides in which two sides are longer, the other two sides are shorter, the longer sides are inclined, and the four sides are coupled together.

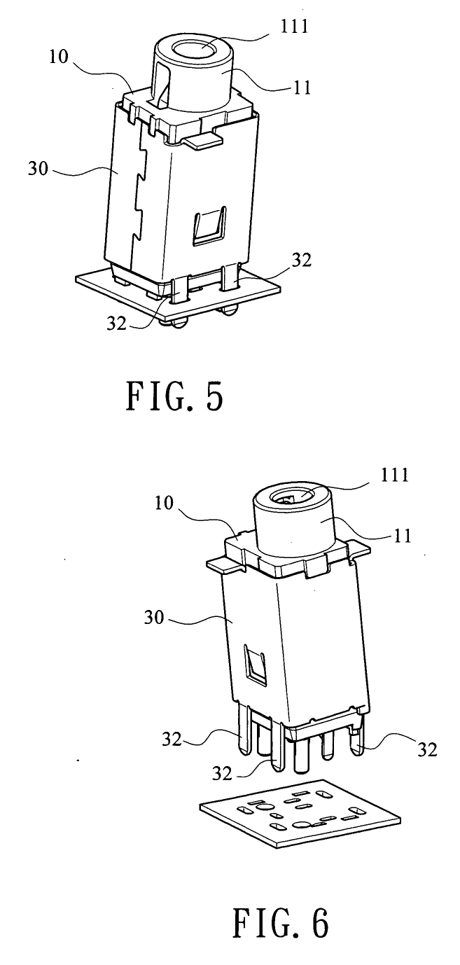

The audio jack further comprises first, second, third, and fourth elongated, thin plate shaped conductors 21, 22, 23, and 24 in which each of the first and the second conductors 21 and 22 has its bent inner terminal 211 positioned in the cavity 1311. In detail, the first conductor 21 is inserted into the first 131 from the rear end 13 until its bent inner terminal 211 positioned in the cavity 1311 of the first groove 131. Similarly, the second conductor 22 is inserted into the second 132 from the rear end 13 until its bent inner terminal 221 positioned in the cavity 1311 of the second groove 132. The bent inner terminals 211 and 221 of the first and second conductors 21 and 22 positioned in the cavities 1311 are adapted to provide an elastic buffering and fastening effect when a plug is inserted into the audio jack. The third and the fourth conductors 23 and 24 are served as a switch and are mounted in the third and the fourth grooves 133 and 134 respectively. Outer terminals 212, 222, 231, and 241 of the first, second, third, and fourth conductors 21, 22, 23, and 24 are slightly inclined and are projected from the rear end 13 so as to electrically connect to a PCB (printed circuit board) as shown in either FIG. 5 or FIG. 6.

The audio jack further comprises a metal shell 30 formed by punching and bending. The shell 30 has a rectangular section and an inclined rear end 31. The shell 30 is adapted to enclose the audio jack and comprises four slightly inclined legs 32 extended from sides of the rear end 31. The slightly inclined legs 32 are adapted to assemble with the PCB. The inclined rear end 31 is constructed substantially the same as the rear end 13. That is, the rear end 31 has four sides in which two sides are longer, the other two sides are shorter, the longer sides are inclined, and the four sides are coupled together.

The PCB is flat. Thus, the audio jack is not perpendicular to the PCB when the slightly inclined legs 32 are inserted into the PCB for fastening. That is, the audio jack is inclined in its fastened state.

While the invention herein disclosed has been described by means of specific embodiments, numerous modifications and variations could be made thereto by those skilled in the art without departing from the scope and spirit of the invention set forth in the claims.

What is claimed is:

1. An audio jack comprising:
a parallelepiped insulative housing 10 including a tapered, inclined rear end 13 having four sides wherein two sides are longer, the other two sides are shorter, the longer sides are inclined, and the four sides are coupled together;
first, second, third, and fourth conductors 21, 22, 23, and 24 each having an outer terminal 212, 222, 231, or 241 inclined and projected from the rear end 13;
a plate 20 mounted inside the housing 10; and
a metal shell 30 of rectangular section including a inclined rear end 31 and a plurality of inclined legs 32 each extended from a respective side of the rear end 31 thereof;
wherein the housing 10 further comprises a plurality of internal cavities 1311 for positioning the first, second, third, and fourth conductors 21, 22, 23, and 24.

2. The audio jack of claim 1, wherein the housing 10 further comprises first and second grooves 131 and 132.

3. The audio jack of claim 2, wherein one cavity 1311 is formed at a close end of the first groove 131.

4. The audio jack of claim 2, wherein the other cavity 1311 is formed at a close end of the second groove 132.

5. The audio jack of claim 1, wherein the inclined rear end 31 of the metal shell 30 has four sides, and wherein two sides are longer, the other two sides are shorter, the longer sides are inclined, and the four sides are coupled together.

6. The audio jack of claim 1, wherein the third and the fourth conductors 23 and 24 are served as a switch and are mounted in the third and the fourth grooves 133 and 134 respectively.

7. The audio jack of claim 1, wherein the outer terminals 212, 222, 231, and 241 of the first, second, third, and fourth conductors 21, 22, 23, and 24 are slightly inclined and are projected from the rear end 13 so as to electrically connect to a PCB (printed circuit board).
